(19) United States
(12) Patent Application Publication
(10) Pub. No.: US 2022/0072585 A1
(43) Pub. Date: Mar. 10, 2022

(54) A PLASMA POLYMERISATION METHOD FOR COATING A SUBSTRATE WITH A POLYMER

(71) Applicant: EUROPLASMA NV, Oudenaarde (BE)

(72) Inventors: Marc Sercu, Roeselare (BE); Samir Loulidi, Temse (BE)

(21) Appl. No.: 17/309,980

(22) PCT Filed: Jan. 8, 2020
(86) PCT No.: PCT/EP2020/050328

§ 371 Date: Jul. 7, 2021

(30) Foreign Application Priority Data
Jan. 9, 2019 (EP) 19151022.1

(51) Int. Cl. B05D 1/00; B05D 3/14; B05D 7/00

(52) U.S. Cl. CPC B05D 1/62; B05D 7/54; B05D 3/142

(57) ABSTRACT

A plasma polymerisation method for coating a substrate with a polymer layer, which method includes: providing a substrate to be coated within a plasma chamber; introducing a flow of a first polymer precursor to the plasma chamber; applying a power at a level greater than zero Watts (W) and converting the first polymer precursor to a first polymer precursor plasma; exposing the substrate to the first polymer precursor plasma; introducing a flow of a second polymer precursor to the plasma chamber; applying a power at a level greater than zero Watts (W) and converting the second polymer precursor to a second polymer precursor plasma; and exposing the substrate to the second polymer precursor plasma, wherein exposing the substrate to the first polymer precursor plasma forms a first polymer layer thereon and exposing the substrate to the second polymer precursor plasma forms a second polymer layer thereon, characterised by maintaining the power at a level greater than zero Watts (W) between exposing the substrate to the first polymer precursor plasma and exposing the substrate to the second polymer precursor plasma.

### TECHNICAL FIELD

The present invention relates to a plasma polymerisation method for coating a substrate (e.g. an electronic device or a component part thereof) with a polymer. In some embodiments, the invention may relate to a plasma polymerisation method for coating a printed circuit board (PCB) with a polymer.

### PRIOR ART

US 2018/0237917 relates to an electroless plating method, in which electroless plating is performed by contacting a substrate which is patterned with an anti-electroless plating coating with an electroless plating solution, whereby metal is deposited by electroless plating onto portions of the substrate that are not patterned with the anti-electroless plating coating. The anti-electroless plating coating is deposited onto a substrate by a plasma deposition process. US 2018/0237917 does not relate to depositing a polymer coating onto a substrate having metallic surfaces, e.g. conductive tracks, and therefore does not suffer from the same drawbacks that the invention of this application is seeking to address.

US 2014/0141221 relates to a method for forming a protective coating on a substrate using plasma enhanced chemical vapour deposition (“PECVD”). It is said that it can be desirable to maintain the plasma through each pulse cycle and between cycles. In other words, this publication teaches that it can be desirable to maintain the plasma during the pressurisation phase, soak phase and evacuation phase of each pulse cycle and also between these pulse cycles. This publication is silent as to what happens to the plasma between exposing the substrate to different precursors.

### BACKGROUND

It is known to coat substrates with polymer layers by plasma polymerisation. Where the substrates have electrically conductive media, for example the conductive tracks of a PCB, the polymer layer can function as a dielectric barrier which can insulate and protect the conductive media from oxidation and/or reduction, thereby reducing the probability of short circuiting and/or degradation of the conductive media when the substrate is exposed to moisture. However, due to the inorganic nature of the substrate, e.g. the electrically conductive media (e.g. copper tracks), and the organic nature of many commercially available polymer coating precursors, it can be difficult to achieve satisfactory adhesion between the polymer coating and the substrate due to their inherent incompatibility. Unsatisfactory adhesion of the polymer coating and the substrate can result in delamination and/or poor performance of the polymer coating.

One known method for improving adhesion between a polymer coating and the substrate is to pre-treat the surface of the substrate prior to depositing the polymer coating thereon. A pre-treatment step can have the effect of removing contamination from the substrate and/or functionalising the substrate so that adhesion of the polymer coating thereto can be improved. Pre-treatment can be carried out by using reactive gases, such as hydrogen or oxygen, and/or by using etching reagents such as tetrafluoromethane. Pre-treatment can also be carried out by using inert gases, such as argon, nitrogen or helium. Mixtures of the foregoing gases/reagents can be used. The pre-treatment step typically involves energising the pre-treatment precursor (i.e. the gas/reagent) to form a pre-treatment precursor plasma and exposing the substrate to the pre-treatment precursor plasma.

In circumstances where the electrically conductive media is formed from copper it has been found that such a pre-treatment step marginally improves the adhesion of the polymer coating to the substrate. However, in circumstances where the electrically conductive media is formed from certain other metals, e.g. gold, such a pre-treatment step can have a negligible effect in terms of improving adhesion of the polymer coating to the substrate.

Another known method for improving adhesion of chiefly organic polymer coatings (i.e. polymers which consist of non-metal elements) and the substrate is to first coat the substrate in a polymer coating that includes a metal element, a metalloid element or a combination thereof, followed by a coating of a polymer consisting of non-metal elements. Polymer coatings including metal and/or metalloid elements have a tendency to better adhere to substrates that are inorganic in nature, e.g. have copper tracks, when compared to polymers consisting of non-metal elements. Moreover, polymers consisting of non-metal elements typically adhere well to polymers including metal and/or metalloid elements. Thus, polymers consisting of non-metal elements can be adhered to a substrate via an intermediate layer of a polymer including metal and/or metalloid elements. In the prior art methods incorporating such an intermediate layer can optionally include the pre-treatment step previously described.

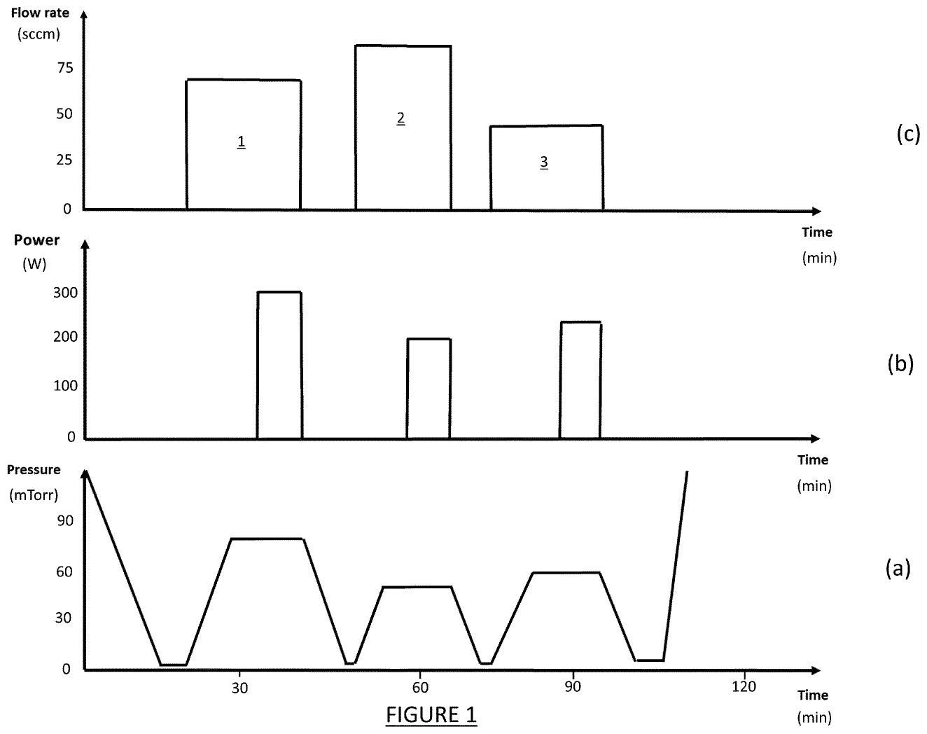

FIG. 1 outlines a plasma polymerisation method for coating a substrate with a polymer layer according to the prior art, where (a) is the absolute pressure (mTorr) within a plasma chamber as a function of time (minutes); (b) is the power (wattage) applied to an electrode set located within the plasma chamber as a function of time (minutes); and (c) is the flow rate (sccm) of a plasma precursor(s) into the plasma chamber as a function of time (minutes).

All quoted timings within the specification are approximate.

The method involves:
pumping down the plasma chamber to a base pressure and allowing the pressure to stablise (0 to 18 minutes);
introducing a pre-treatment precursor 1 to the plasma chamber and increasing the pressure to a pre-treatment precursor operating pressure (18 to 26 minutes);
pre-treating a substrate by applying a power of approximately 300 W to convert the pre-treatment precursor 1 to a pre-treatment precursor plasma and exposing the substate to the pre-treatment precursor plasma (30 to 40 minutes);
switching off the power and the flow of the pre-treatment precursor 1 (40 minutes);
pumping down the plasma chamber to a base pressure and allowing the pressure to stablise (40 to 50 minutes);
introducing a first polymer precursor 2 to the plasma chamber and increasing the pressure to a first polymer precursor operating pressure (50 to 54 minutes);
depositing a first polymer layer on the substrate by applying a power of approximately 200 W to convert the first polymer precursor 2 to a first polymer precursor plasma and exposing the substate to the first polymer precursor plasma to form a first polymer layer thereon (58 to 66 minutes);
switching off the power and the flow of the first polymer precursor 2 (66 minutes);
pumping down the plasma chamber to a base pressure and allowing the pressure to stablise (66 to 74 minutes);
introducing a second polymer precursor 3 to the plasma chamber and increasing the pressure to a second polymer precursor operating pressure (74 to 82 minutes);
depositing a second polymer layer on the first polymer layer by applying a power of approximately 240 W to convert the second polymer precursor 3 to a second polymer precursor plasma and exposing the first polymer layer to the second polymer precursor plasma to form a second polymer layer thereon (85 to 94 minutes);
switching off the power and the flow of the second polymer precursor 3 (94 minutes); and
pumping down the plasma chamber to a base pressure and allowing the pressure to stablise (94 to 105 minutes).

Whilst the plasma chamber is at base pressure the chamber and any associate tubing may be purged with an inert gas to remove any residual precursors, following which the plasma chamber may be aerated to allow removal of all substances therefrom.

A number of problems associated with this known method have been identified which can negatively impact on adhesion of the first polymer layer to the substrate and/or adhesion between the first and second polymer layers. In particular, it has been found that the during the period between the pre-treatment step and deposition of the first polymer layer and the period between deposition of the first and second polymer layers contamination from the atmosphere can interact with the surface of the substrate or any polymer layer deposited thereon. Interaction of such contamination, e.g. contamination that either occupies active sites on or bonds with the substrate or any polymer layer deposited thereon, can reduce the adhesion of any subsequent polymer layer(s) thereto.

Accordingly, there is a need for improved plasma polymerisation methods.

### SUMMARY OF INVENTION

Embodiments of the present invention seek to improve the adhesion of polymer coatings to substrates (such as electronic devices or component parts thereof, e.g. PCBs). In particular, embodiments of the invention seek to improve the adhesion of polymer coatings to metallic surfaces of substrates, e.g. the conductive tracks of a PCB.

According to a first aspect of the invention, we provide a plasma polymerisation method for coating a substrate with a polymer layer, which method comprises: providing a substrate to be coated within a plasma chamber;
introducing a flow of a pre-treatment precursor to the plasma chamber;
applying a power at a level greater than zero Watts (W) and converting the pre-treatment precursor to a pre-treatment precursor plasma; and
exposing the substrate to the pre-treatment precursor plasma;
introducing a flow of a first polymer precursor to the plasma chamber;
applying a power at a level greater than zero Watts (W) and converting the first polymer precursor to a first polymer precursor plasma;
exposing the substrate to the first polymer precursor plasma;
introducing a flow of a second polymer precursor to the plasma chamber;
applying a power at a level greater than zero Watts (W) and converting the second polymer precursor to a second polymer precursor plasma; and
exposing the substrate to the second polymer precursor plasma,

wherein exposing the substrate to the first polymer precursor plasma forms a first polymer layer thereon and exposing the substrate to the second polymer precursor plasma forms a second polymer layer thereon, characterised by maintaining the power at a level greater than zero Watts (W) between exposing the substrate to the pre-treatment precursor plasma and exposing the substrate to the first polymer precursor plasma and between exposing the substrate to the first polymer precursor plasma and exposing the substrate to the second polymer precursor plasma.

According to a second aspect of the invention, we provide a plasma polymerisation method for coating a substrate with a polymer layer, which method comprises:
providing a substrate to be coated within a plasma chamber;
introducing a flow of a first polymer precursor to the plasma chamber;
applying a first power at a level greater than zero Watts (W) and converting the first polymer precursor to a first polymer precursor plasma;
exposing the substrate to the first polymer precursor plasma;
introducing a flow of a second polymer precursor to the plasma chamber;
applying a second power at a level greater than zero Watts (W) and converting the second polymer precursor to a second polymer precursor plasma; and
exposing the substrate to the second polymer precursor plasma,

wherein the second power level is different from the first power level and wherein exposing the substrate to the first polymer precursor plasma forms a first polymer layer thereon and exposing the substrate to the second polymer precursor plasma forms a second polymer layer thereon, characterised by switching the power immediately from the first power level to the second power level and maintaining the power at the second power level.

The second power level may be lower than the first power level such that the power is reduced immediately from the first power level to the second power level.

According to a third aspect of the invention, we provide a plasma polymerisation method for coating a substrate with a polymer layer, which method comprises:
providing a substrate to be coated within a plasma chamber;
introducing a flow of a pre-treatment precursor to the plasma chamber;
applying a first power at a level greater than zero Watts (W) and converting the pre-treatment precursor to a pre-treatment precursor plasma;
exposing the substrate to the pre-treatment precursor plasma;
introducing a flow of a first polymer precursor to the plasma chamber;
applying a second power at a level greater than zero Watts (W) and converting the first polymer precursor to a first polymer precursor plasma; and
exposing the substrate to the first polymer precursor plasma,

wherein exposing the substrate to the first polymer precursor plasma forms a first polymer layer thereon, characterised by maintaining the power at a level greater than zero Watts (W) between exposing the substrate to the pre-treatment precursor plasma and exposing the substrate to the first polymer precursor plasma.

The effect of maintaining the power at a level greater than zero Watts (W) between exposing the substrate to the pre-treatment precursor plasma and exposing the substrate to the first polymer precursor plasma and/or maintaining the power at a level greater than zero Watts (W) between exposing the substrate to the first polymer precursor plasma and exposing the substrate to the second polymer precursor plasma is that a plasma state can be maintained within the plasma chamber. It has been determined that by maintaining a plasma state within the plasma chamber the interaction of any contamination (e.g. condensation or unreacted polymer precursor) with the substrate and/or the first polymer layer can be reduced, thereby improving the overall adhesion of the first and/or the second polymer layer(s) thereto.

It is to be appreciated that the power required to maintain a plasma state within the plasma chamber will vary depending on various factors, such as the type of precursor that is being converted into plasma. Accordingly, in some embodiments, the power which converts the second polymer precursor to the second polymer precursor plasma may differ from the power which converts the first polymer precursor to the first polymer precursor plasma, particularly in embodiments where the second polymer precursor differs from the first polymer precursor.

The skilled person understands what level of power is required to maintain various different precursors in the plasma state. However, for the avoidance of any doubt, between exposing the substrate to the pre-treatment precursor plasma, the first polymer precursor plasma and/or the second polymer precursor plasma the power may be maintained at a level greater than 5 W or a level greater than 10 W or a level greater than 15 W or a level greater than 20 W or a level greater than 25 W or a level greater than 30 W or a level greater than 35 W or a level greater than 40 W or a level greater than 45 W, such as a level of approximately 50 W.

The method may include setting the pressure within the plasma chamber to a first polymer precursor operating pressure for converting the first polymer precursor into the first polymer precursor plasma and setting the pressure within the plasma chamber to a second polymer precursor operating pressure for converting the second polymer precursor into the second polymer precursor plasma.

The method may include changing (i.e. reducing or increasing) the pressure from the first polymer precursor operating pressure to the second polymer precursor operating pressure without reducing the pressure to base pressure.

Changing the pressure from the first polymer precursor operating pressure to the second polymer precursor operating pressure without reducing the pressure to base pressure can further minimise contamination of the first polymer layer deposited thereon. Moreover, by not reducing the pressure to base pressure it has been found that the degree of any contamination, such as condensation, on the first polymer layer can be reduced. Reducing contamination on the first polymer layer can improve adhesion of the second polymer layer thereto.

The method may include changing the pressure from the first polymer precursor operating pressure to the second polymer precursor operating pressure concurrent with introducing the second polymer precursor to the plasma chamber.

The method may include reducing the flow of the first polymer precursor (e.g. to zero flow) concurrent with increasing the flow of the second polymer precursor to the plasma chamber.

The second polymer precursor may differ from the first polymer precursor.

The first polymer precursor and/or the second polymer precursor may comprise one or a combination of differing species.

The first polymer precursor may be a polymer precursor monomer comprising a metal element, a metalloid element or a combination thereof.

The metal element may be selected from the group consisting of Al, Fe, Co, Ni, Cu, Zn, Ag, Sn, Au or any combination thereof.

The metalloid element may be selected from the group consisting of B, Si, Ge, As, Sb, Te, Po or any combination thereof.

The method may involve introducing a flow of one or more additional polymer precursor(s) to the plasma chamber to provide the substrate with a multi-layer polymer coating. For example, a third polymer precursor may be introduced as the flow of the second polymer precursor is reduced. In such embodiments, the power may be changed to suit the third polymer precursor without reducing the power to zero watts and/or the pressure may be changed to a third polymer precursor operating pressure without reducing the pressure to base pressure so as to realise the previously mentioned advantages.

The second and/or any additional polymer precursor(s) may be a polymer precursor monomer(s) consisting of non-metal elements.

In some embodiments, the method may comprise a pre-treatment step prior to introducing the flow of the first polymer precursor to the plasma chamber, the pre-treatment step comprising:
introducing a flow of a pre-treatment precursor to the plasma chamber;
applying a power at a level greater than zero Watts (W) and converting the pre-treatment precursor to a pre-treatment precursor plasma; and
exposing the substrate to the pre-treatment precursor plasma,

wherein the power is maintained at a level greater than zero Watts (W) between exposing the substrate to the pre-treatment precursor plasma and exposing the substrate to the first polymer precursor plasma.

By maintaining the power at a level greater than zero Watts (W) between the pre-treatment and exposing the substrate to the first polymer layer the previously mentioned advantages may be realised.

The pre-treatment step may include setting the pressure within the plasma chamber to a pre-treatment precursor operating pressure for converting the pre-treatment precursor to the pre-treatment precursor plasma and changing the pressure from the pre-treatment precursor operating pressure to the first polymer precursor operating pressure without reducing the pressure to base pressure.

Again, by maintaining pressure within the plasma chamber between pre-treatment and exposing the substrate to the first polymer layer the previously mentioned advantages may be realised.

The method may include reducing the flow of the pre-treatment precursor (e.g. to zero flow) concurrent with increasing the flow of the first polymer precursor.

According to a second aspect of the invention, we provide a substrate comprising a surface having a polymer coating formed thereon by a plasma polymerisation method according to the first aspect.

The surface of the substrate may include a metal element, a metalloid element or a combination thereof prior to having the polymer coating deposited thereon.

### Pre-Treatment Step

The pre-treatment step may be optional.

In embodiments including the pre-treatment step, the pre-treatment precursor may include one or more reactive gases, such as hydrogen and oxygen, one or more etching agents such as tetrafluoromethane, or one or more inert gases, such as argon, nitrogen or helium.

The pre-treatment precursor is energised to form a pre-treatment precursor plasma which is exposed to the substrate to clean and/or activate the surface thereof.

### First Polymer Layer

The first polymer layer may represent an adhesion promoting layer. In such embodiments, a function of the first polymer layer is to provide an intermediate layer for improving adhesion of the second polymer layer to the substrate. Accordingly, the first polymer precursor may comprise inorganic elements, such as one or more metal and/or metalloid elements. These inorganic elements can have an affinity with inorganic elements within the substrate and also an affinity with organic elements of the second polymer layer, thereby improving adhesion of the second polymer layer to the substrate.

The first polymer precursor may comprise a compound having the general formula (I):

Y1-X—Y2 (I)

wherein X is O or NH, Y1 is —Si(Y3)(Y4)Y5 and Y2 is Si(Y3′)(Y4′)Y5′, wherein Y3, Y4, Y5, Y3′, Y4′, and Y5′ are each independently H or an alkyl group of up to 10 carbon atoms; wherein at most one of Y3, Y4 and Y5 is hydrogen, at most one of Y3′, Y4′ and Y5′ is hydrogen; and the total number of carbon atoms is not more than 20.

The first polymer precursor may comprise a compound having the general formula (II):

—[Si(R1)(R2)-X-]n- (II)

wherein (II) is cyclic and n is 2 to 10, wherein X is O or NH, wherein R1 and R2 are each independently H, an alkyl group of up to 10 carbon atoms or an alkoxy group —O—Z, wherein Z is preferably —CtH2t+1, wherein t is 1 to 10.

The first polymer precursor may comprise a compound having the general formula (III):

C(R2)(R3)=C(R4)-Si(R5)(R6)(R7) (III)

wherein R2, R3, R4, R5, R6 and R7 are each independently H or an alkyl group of up to 10 carbon atoms or an alkoxy group —O—Z, wherein Z is preferably —CtH2t+1, wherein t is 1 to 10.

The first polymer precursor may comprise a compound having the general formula (IV):

(R5)Si(R6)(R7)(R8) (IV)

wherein R5, R6, R7 and R8 are each independently H, an alkyl group of up to 10 carbon atoms or an alkoxy group —O—Z, wherein Z is preferably —CtH2t+1, wherein t is 1 to 10.

The first polymer precursor may comprise a compound having the general formula (V):

C(R9)(R10)=C(R11)C(O)—O—R12-Si(R13)(R14)(R15) (V)

wherein R9, R10, R11, R12, R13, R14 and R15 are each independently H, an alkyl group of up to 10 carbon atoms or an alkoxy group —O—Z, wherein Z is preferably —CtH2t+1, wherein t is 1 to 10.

The first polymer precursor may comprise a compound having the general formula (VI):

—[Si(C(R16)=C(R17)(R18))(R19)-X-]n- (VI)

wherein VI is cyclic and n is 2 to 10, wherein X is O or NH, and wherein R16, R17, R18 and R19 are each independently H, an alkyl group of up to 10 carbon atoms or an alkoxy group —O—Z, wherein Z is preferably —CtH2t+1, wherein t is 1 to 10.

The first polymer precursor may comprise a compound having the general formula (VII):

C(R20)(R21)=C(R22)-Si(R23)(R24)-X—Si(R25)(R26)-C(R27)=C(R28)(R29) (VII)

wherein X is O or NH, and wherein R20, R21, R22, R23, R24, R25, R26, R27, R28 and R29 are each independently H, an alkyl group of up to 10 carbon atoms or an alkoxy group —O—Z, wherein Z is preferably —CtH2t+1, wherein t is 1 to 10.

The alkyl groups of any of the compounds (I) to (VII) may be straight or branched-chain. The alkyl groups may be methyl or ethyl groups. All of Y3, Y4, Y5, Y3′, Y4′ or Y5′ may be alkyl groups.

The alkoxy groups of any of the compounds (I) to (VII) may be straight, branched-chain or cyclic. The alkoxy groups may be methoxy or ethoxy groups.

The first polymer precursor may be any one or a combination of:

hexamethyldisiloxane;

octamethylcyclotetrasiloxane;

hexamethylcyclotrisilazane;

3-(trimethoxysilyl)propyl methacrylate;

1,3,5,7-tetravinyl-1,3,5,7-tetramethylcyclotretrasiloxane; and

1,3 divinyltetramethyldisiloxane.

Deposition of the first polymer layer on the substrate may include (i) plasma polymerisation of the first polymer precursor and deposition of the resultant first polymer precursor plasma on the substrate; (ii) exposing the first polymer layer to an inert gas in the presence of a plasma without further deposition of polymer; and (iii) optionally repeating (i) and (ii) at least once more. Such a method is described in WO 2017/051019 A1, the contents of which are herein incorporated by reference.

The inert gas may comprise Ar, N₂, He, Ne, Kr, Xe, or a mixture thereof.

An advantage of repeating (i) and (ii) is that multiple discrete regions of increased polymer density can be introduced through the first polymer layer, thereby improving the dielectric properties thereof.

### Second and any Subsequent Polymer Layer(s)

The second and/or any subsequent polymer layer(s) may be formed from polymer precursor monomers that consist of non-metal elements and are therefore deemed to be organic in nature. Such organic polymers typically function better at providing a dielectric barrier than polymers formed from precursor monomers that include metal and/or metalloid elements.

The second and any subsequent polymer precursor(s) may comprise a compound having the general formula (VIII):

C(R30)(R31)=C(R32)-(V1)x-C(R33)=C(R34)(R35) (VIII)

wherein V1 is a benzene group with x referring to the position of the side groups either being ortho (1,2), meta (1,3) or para (1,4) oriented and wherein R30, R31, R32, R33, R34 and R35 are an independently H or an alkyl group of 1 up to 8 carbon atoms.

The second and any subsequent polymer precursor(s) may comprise a compound having the general formula (IX):

C(R36)(R37)=C(R38)(R39) (IX)

wherein R36, R37, R38 and R39 are each independently H, an alkyl group of 1 up to 8 carbon atoms.

The second and any subsequent polymer precursor(s) may comprise a compound having the general formula (X):

C(R40)≡(R41) (X)

wherein R40 and R41 are each independently H, an alkyl group of 1 up to 8 carbon atoms.

The second and any subsequent polymer precursor(s) may comprise a compound having the general formula (XI):

C(R42)(R43)=C(R44)-R45-C(R46)=C(R47)(R48) (XI)

wherein R42, R43, R44, R46, R47 and R48 is H or an alkyl group of 1 up to 8 carbon atoms, and wherein R45 is an alkyl group of 1 up to 8 carbon atoms.

The second and any subsequent polymer precursor(s) may comprise a compound having the general formula (XII):

[C(R49)=C(R50)-R51]n- (XII)

wherein (XII) is cyclic and n is 1 to 10, wherein R49 and R50 are each independently H or an alkyl group of 1 up to 8 carbon atoms and wherein R51 is an alkyl group of 1 up to 8 carbon atoms.

The alkyl groups of any of the compounds (VIII) to (XII) may be straight or branched-chain. The alkyl groups may be methyl or ethyl groups. All of Y3, Y4, Y5, Y3′, Y4′ or Y5′ may be alkyl groups.

The second and any subsequent polymer precursor(s) may be any one or a combination of:

1,3-diisopropenylbenzene;

ethylene;

ethyne;

1,7-octadiene; and

1,5-cylcooctadiene.

However, in some embodiments, the second and any subsequent polymer precursors may comprise inorganic elements, such as one or more metal and/or metalloid elements. For instance, the second and any subsequent polymer precursors may comprise a compound having the general formula (I) to (VII).

Accordingly, in some embodiments the second and any subsequent polymer precursor(s) may be any one or a combination of:

hexamethyldisiloxane;

octamethylcyclotetrasiloxane;

hexamethylcyclotrisilazane;

3-(trimethoxysilyl)propyl methacrylate;

1,3,5,7-tetravinyl-1,3,5,7-tetramethylcyclotretrasiloxane; and

1,3 divinyltetramethyldisiloxane.

Deposition of the second and any subsequent polymer layer(s) on the substrate may include (i) plasma polymerisation of the second/subsequent polymer precursor(s) and deposition of the resultant second/subsequent polymer precursor plasma(s) on the substrate; (ii) exposing the second/subsequent polymer layer(s) to an inert gas in the presence of a plasma without further deposition of polymer; and (iii) optionally repeating (i) and (ii) at least once more. Such a method is described in WO 201 7/051 01 9 A1.

The inert gas may comprise Ar, N₂, He, Ne, Kr, Xe, or a mixture thereof.

An advantage of repeating (i) and (ii) is that multiple discrete regions of increased polymer density can be introduced through the second/subsequent polymer layer(s), thereby improving the dielectric properties thereof.

### DETAILED DESCRIPTION OF INVENTION

Embodiments of the present invention will now be described, by way of example only, with reference to the accompanying figures.

FIG. 1 illustrates a plasma polymerisation method according to the prior art;

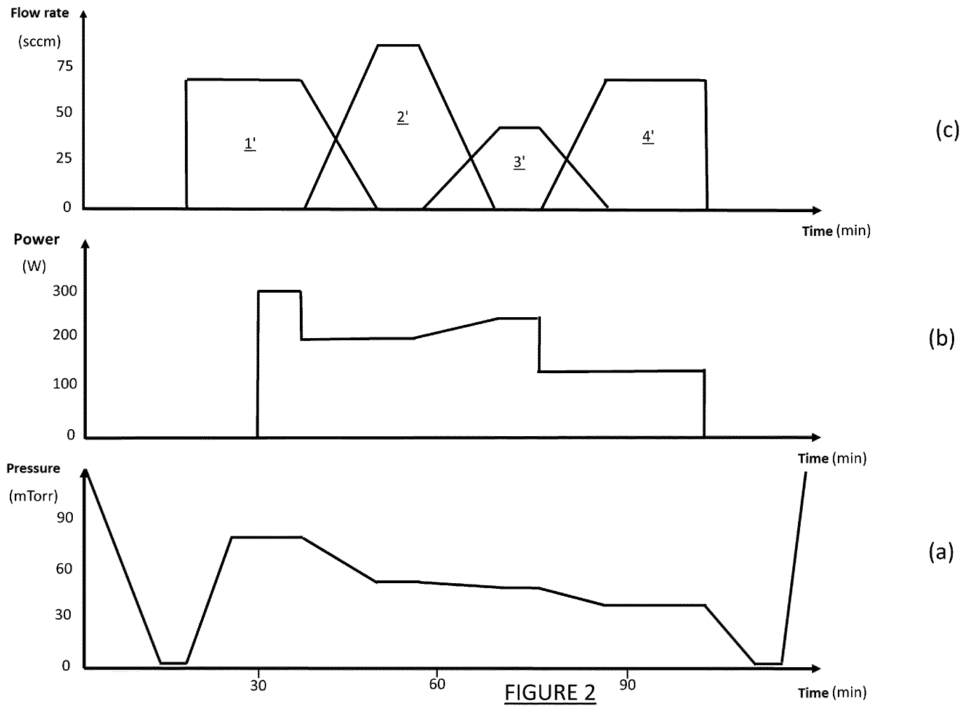

FIG. 2 illustrates a plasma polymerisation method according to an embodiment of the invention; and

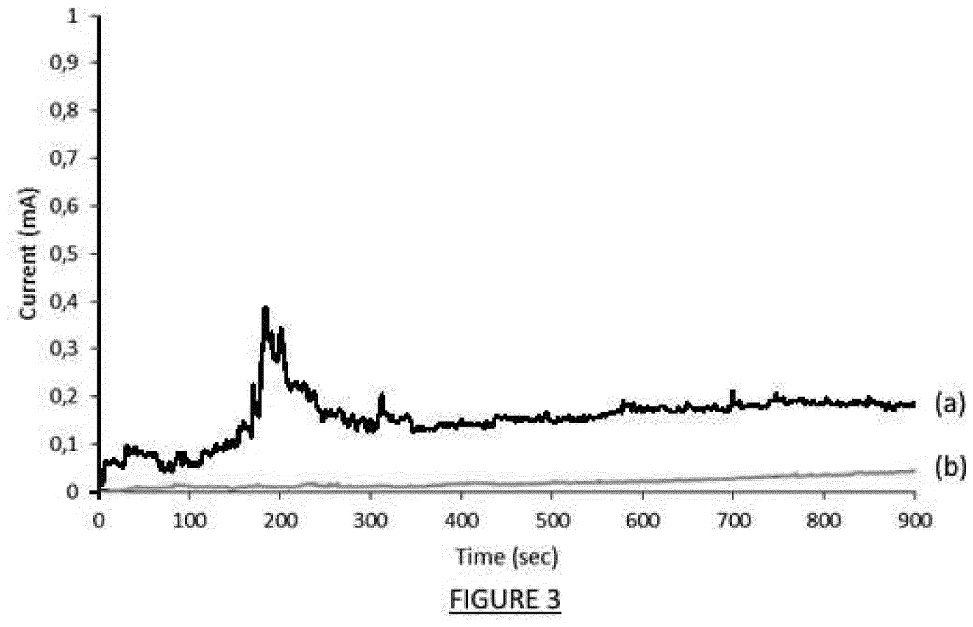

FIG. 3 shows a graph comparing results of shortcut tests carried out on PCBs that have been coated with polymers using methods according to the prior art (3a) and the invention (3b).

FIG. 2 outlines a plasma polymerisation method for coating a substrate with a polymer layer according to the present invention, where (a) is the absolute pressure (mTorr) within a plasma chamber as a function of time (minutes); (b) is the power (wattage) applied to an electrode set located within the plasma chamber as a function of time (minutes); and (c) is the flow rate (sccm) of a plasma precursor(s) into the plasma chamber as a function of time (minutes).

The method may involve:
pumping down the plasma chamber to a base pressure and allowing the pressure to stablise (0 to 19 minutes);
introducing a pre-treatment precursor 1′ to the plasma chamber and increasing the pressure to a pre-treatment precursor operating pressure (19 to 24 minutes);
pre-treating a substrate by applying a power of approximately 300 W to convert the pre-treatment precursor 1′ to a pre-treatment precursor plasma and exposing the substate to the pre-treatment precursor plasma (30 to 36 minutes);
reducing the flow of the pre-treatment precursor 1′ to zero concurrent with increasing the flow of a first polymer precursor 2′ (36 to 48 minutes);
reducing the power from approximately 300 W to approximately 200 W (36 minutes);
reducing the pressure from the pre-treatment precursor operating pressure to a first polymer precursor operating pressure without reducing the pressure to base pressure (36 to 48 minutes);
depositing a first polymer layer on the substrate by applying a power of approximately 200 W to convert the first polymer precursor 2′ to a first polymer precursor plasma and exposing the substate to the first polymer precursor plasma to form a first polymer layer thereon (48 to 55 minutes);
reducing the flow of the first polymer precursor 2′ to zero concurrent with increasing the flow of a second polymer precursor 3′ (55 to 70 minutes);
increasing the power from approximately 200 W to approximately 240 W (55 to 70 minutes);
reducing the pressure from the first polymer precursor operating pressure to a second polymer precursor operating pressure without reducing the pressure to base pressure (55 to 70 minutes);
depositing a second polymer layer on the substrate by applying a power of approximately 240 W to convert the second polymer precursor 3′ to a second polymer precursor plasma and exposing the substate to the second polymer precursor plasma to form a second polymer layer thereon (70 to 76 minutes);
reducing the flow of the second polymer precursor 3′ to zero concurrent with increasing the flow of a third polymer precursor 4′ (76 to 86 minutes);
reducing the power from approximately 240 W to approximately 125 W (76 minutes);
reducing the pressure from the second polymer precursor operating pressure to a third polymer precursor operating pressure without reducing the pressure to base pressure (76 to 86 minutes);
depositing a third polymer layer on the substrate by applying a power of approximately 125 W to convert the third polymer precursor 4′ to a third polymer precursor plasma and exposing the substate to the third polymer precursor plasma to form a third polymer layer thereon (86 to 103 minutes);
switching off the power and the flow of the third polymer precursor 4′ (103 minutes); and
pumping down the plasma chamber to a base pressure and allowing the pressure to stablise (103 to 116 minutes).

Whilst the plasma chamber is at base pressure the chamber and any associate tubing may be purged with an inert gas to remove any residual precursors, following which the plasma chamber may be aerated to allow removal of all substances therefrom.

By ensuring that the power does not reduce to zero W during the course of the method means that a plasma state (even if only a weak plasma state) is maintained within the plasma chamber which can have the effect of reducing contamination on the substrate and the polymer layers. Advantageously, adhesion of the polymer layers to the substrate—in particular the conductive tracks of a PCB—is improved when compared to prior art methods.

It has further been determined that switching the power immediately from a first power level to a second power level and then maintaining the power at the second power level can be beneficial, especially in instances where the second power level is required to be lower than the first power level. A power level is typically reduced when a polymer precursor having greater reactivity than the present precursor is introduced to the plasma chamber. In reducing the power immediately—rather than gradually over time—less undesirable fragmentation of the polymer precursor being introduced is observed.

Moreover, ensuring that the pressure does not reduce to base pressure during the course of the method has been found to further reduce contamination and condensation on the substrate and the polymer layers, thereby further improving adhesion of the polymer layers to the substrate when compared to prior art methods.

Furthermore, introducing the polymer precursors to the plasma chamber for a period of time concurrently can achieve a polymer coating having a composition that varies through its thickness. For example, in embodiments where the polymer coating is formed from two discrete polymer precursor, the base of the polymer coating (i.e. closest to the substrate) may comprise polymer formed predominantly from the first polymer precursor 2′, the surface of the polymer coating (i.e. furthest from the substrate) may comprise polymer formed predominantly from the second polymer precursor 3′ and the region between the base and the surface may comprise polymer formed from a mixture of the first and second polymer precursors 2′, 3′. The concentration of polymer formed from the first polymer precursor 2′ may decrease gradually moving towards the surface and the concentration of polymer formed from the second polymer precursor 3′ may increase gradually moving towards the surface.

Whilst included in the method of FIG. 2, it is to be appreciated that the pre-treatment step and deposition of the third polymer layer are optional.

It is also to be appreciated that the invention is not to be in any way limited by the specified flow rates, powers, pressures and/or timings of the described examples. These parameters are merely explanatory and may differ depending on factors such as any one or more of the volume of the plasma chamber, the chemistry of the precursors, the thickness of the desired coating(s) and so forth.

For a plasma chamber having a volume of 0.282 m³ the parameters may fall within the below ranges.

The plasma deposition method may have an overall time of from approximately 5 minutes to approximately 600 minutes.

Plasma polymerisation may be continuous wave or pulsed wave. Whether continuous wave or pulsed wave plasma is used depends on various factors such as the chemistry of the precursors, the volume and/or the design of the plasma chamber.

The applied power may be from approximately 5 W to approximately 2000 W.

The precursor operating pressures may be from approximately 2 mTorr to approximately 150 mTorr, preferably approximately 2 mTorr to approximately 100 mTorr.

In order to demonstrate that the inventive method is an improvement over known methods electrical shortcut tests were carried out. The shortcut tests involved immersing a polymer-coated PCB in artificial sweat solution, applying a voltage (5V) across the polymer coating and continuously measuring the current at the conductive tracks of the PCB for 900 seconds.

FIG. 3a is a plot of the measured current (mA) versus time (seconds) for a PCB having a polymer coating deposited thereon according to the prior art method of FIG. 1. FIG. 3b is a corresponding plot for a PCB having a polymer coating deposited thereon according to the inventive method defined by claim 1.

The applied polymer coatings had the same thickness of 1 μm for comparative purposes. Shortcut tests were conducted twice on each PCB and mean values for the measured currents were determined and used to plot the graphs.

It is clear from FIG. 3 that the polymer coating deposited using the inventive method (which corresponds to plot 3b) is less conductive through its thickness than the polymer coating deposited using the prior art method (which corresponds to plot 3a). In other words, the polymer coating deposited using the inventive method is more electrically resistant than the polymer coating deposited using the prior art method. It is considered by the inventors that this improvement in electrical resistivity is due to better adhesion of polymer to the substrate by virtue of maintaining a plasma state inside the plasma chamber when depositing the polymer layers.

The described example are of polymer coatings that have been deposited on PCBs, although it has been determined that the inventive methods can also improve adhesion of polymers to other substrates that include inorganic species, such as other components having metallic surfaces, e.g. batteries.

When used herein, the term “organic polymer” is intended to mean a polymer which consists of non-metal elements. Such organic polymers do not include any metal elements and/or metalloid elements.

When used herein, the term “inorganic polymer” is intended to mean a polymer which includes at least one metal element or metalloid element.

When used herein, the term “metalloid element” is intended to mean elements of the periodic table that are selected from the group consisting of B, Si, Ge, As, Sb, Te and Po.

When used herein, the term “non-metal element” is intended to mean elements of the periodic table that are selected from the group consisting H, He, C, N, O, F, Ne, P, S, Cl, Ar, Se, Br, Kr, I, Xe and Rn.

When used herein, the term “metal element” is intended to mean elements of the periodic table that do not fall within the definitions of “metalloid element” and “non-metal element”.

When used herein, the term “base pressure” is intended to refer to the lowest pressure that a plasma chamber can be pumped down to without any gases flowing. It is to be appreciated that base pressures can vary from plasma chamber to plasma chamber since the value is dependent on various factors, such as the size of the plasma chamber, the configuration of the plasma chamber, the efficiency of the vacuum pump, leaks associated with the plasma chamber and so forth.

The term “immediately” when used herein to describe a change in power level is intended to mean that the power level is instantly switched from one power level to another power level without stepping through any intermediate power levels. In other words, the immediate switch would be represented by a vertical line when viewed on a plot of power (y-axis) versus time (x-axis), e.g. FIG. 2(b) at approximately 36 minutes and 76 minutes.

When used herein, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

Although certain example embodiments of the invention have been described, the scope of the appended claims is not intended to be limited solely to these embodiments. The claims are to be construed literally, purposively, and/or to encompass equivalents.

1. A plasma polymerisation method for coating a substrate with a polymer layer, which method comprises:
providing a substrate to be coated within a plasma chamber;
introducing a flow of a pre-treatment precursor to the plasma chamber;
applying a power at a level greater than zero Watts (W) and converting the pre-treatment precursor to a pre-treatment precursor plasma; and
exposing the substrate to the pre-treatment precursor plasma;
introducing a flow of a first polymer precursor to the plasma chamber;
applying a power at a level greater than zero Watts (W) and converting the first polymer precursor to a first polymer precursor plasma;
exposing the substrate to the first polymer precursor plasma;
introducing a flow of a second polymer precursor to the plasma chamber;
applying a power at a level greater than zero Watts (W) and converting the second polymer precursor to a second polymer precursor plasma; and
exposing the substrate to the second polymer precursor plasma,
wherein exposing the substrate to the first polymer precursor plasma forms a first polymer layer thereon and exposing the substrate to the second polymer precursor plasma forms a second polymer layer thereon, characterised by maintaining the power at a level greater than zero Watts (W) between exposing the substrate to the pre-treatment precursor plasma and exposing the substrate to the first polymer precursor plasma and between exposing the substrate to the first polymer precursor plasma and exposing the substrate to the second polymer precursor plasma.

2. A plasma polymerisation method according to claim 1, wherein the power which converts the second polymer precursor to the second polymer precursor plasma is different from the power which converts the first polymer precursor to the first polymer precursor plasma.

3. A plasma polymerisation method for coating a substrate with a polymer layer, which method comprises:
providing a substrate to be coated within a plasma chamber;
introducing a flow of a first polymer precursor to the plasma chamber;
applying a first power at a level greater than zero Watts (W) and converting the first polymer precursor to a first polymer precursor plasma;
exposing the substrate to the first polymer precursor plasma;
introducing a flow of a second polymer precursor to the plasma chamber;
applying a second power at a level greater than zero Watts (W) and converting the second polymer precursor to a second polymer precursor plasma; and
exposing the substrate to the second polymer precursor plasma,
wherein the second power level is different from the first power level and wherein exposing the substrate to the first polymer precursor plasma forms a first polymer layer thereon and exposing the substrate to the second polymer precursor plasma forms a second polymer layer thereon, characterised by switching the power immediately from the first power level to the second power level and maintaining the power at the second power level.

4. A plasma polymerisation method according to claim 3, wherein the second power level is lower than the first power level such that the power is reduced immediately from the first power level to the second power level.

5. A plasma polymerisation method according to claim 1, including setting the pressure within the plasma chamber to a first polymer precursor operating pressure for converting the first polymer precursor to the first polymer precursor plasma and setting the pressure within the plasma chamber to a second polymer precursor operating pressure for converting the second polymer precursor to the second polymer precursor plasma.

6. A plasma polymerisation method according to claim 5, including changing the pressure from the first polymer precursor operating pressure to the second polymer precursor operating pressure without reducing the pressure to base pressure.

7. A plasma polymerisation method according to claim 5, including changing the pressure from the first polymer precursor operating pressure to the second polymer precursor operating pressure concurrent with introducing the second precursor to the plasma chamber.

8. A plasma polymerisation method according to claim 1, including reducing the flow of the first polymer precursor to the plasma chamber concurrent with increasing the flow of the second polymer precursor to the plasma chamber.

9. A plasma polymerisation method according to claim 1, wherein the second polymer precursor is different from the first polymer precursor.

10. A plasma polymerisation method according to claim 1, wherein the first polymer precursor is a polymer precursor monomer comprising a metal element, a metalloid element or a combination thereof.

11. A plasma polymerisation method according to claim 10, wherein the metal element is selected from the group consisting of Al, Fe, Co, Ni, Cu, Zn, Ag, Sn, Au or any combination thereof.

12. A plasma polymerisation method according to claim 10, wherein the metalloid element is selected from the group consisting of B, Si, Ge, As, Sb, Te, Po or any combination thereof.

13. A plasma polymerisation method according to claim 1, wherein the second polymer precursor is a polymer precursor monomer consisting of non-metal elements.

14. A plasma polymerisation method for coating a substrate with a polymer layer, which method comprises:
providing a substrate to be coated within a plasma chamber;
introducing a flow of a pre-treatment precursor to the plasma chamber;
applying a first power at a level greater than zero Watts (W) and converting the pre-treatment precursor to a pre-treatment precursor plasma;
exposing the substrate to the pre-treatment precursor plasma;
introducing a flow of a first polymer precursor to the plasma chamber;
applying a second power at a level greater than zero Watts (W) and converting the first polymer precursor to a first polymer precursor plasma; and
exposing the substrate to the first polymer precursor plasma,
wherein exposing the substrate to the first polymer precursor plasma forms a first polymer layer thereon, characterised by maintaining the power at a level greater than zero Watts (W) between exposing the substrate to the pre-treatment precursor plasma and exposing the substrate to the first polymer precursor plasma.

15. A plasma polymerisation method according to claim 14, wherein the second power level is different from the first power level.

16. A plasma polymerisation method according to claim 14, including switching the power immediately from the first power level to the second power level and maintaining the power at the second power level.

17. A plasma polymerisation method according to claim 16, wherein the second power level is lower than the first power level such that the power is reduced immediately from the first power level to the second power level.

18. A plasma polymerisation method according to claim 1, including setting the pressure within the plasma chamber to a pre-treatment precursor operating pressure for converting the pre-treatment precursor to the pre-treatment precursor plasma and setting the pressure within the plasma chamber to a first polymer precursor operating pressure for converting the first polymer precursor to the first polymer precursor plasma.

19. A plasma polymerisation method according to claim 18, wherein the pressure is changed from the pre-treatment precursor operating pressure to the first polymer precursor operating pressure without reducing the pressure to base pressure.

20. A plasma polymerisation method according to claim 18, including changing the pressure from the pre-treatment precursor operating pressure to the first polymer precursor operating pressure concurrent with introducing the first polymer precursor to the plasma chamber.

21. A plasma polymerisation method according to claim 14, including reducing the flow of the pre-treatment polymer precursor to the plasma chamber concurrent with increasing the flow of the first polymer precursor to the plasma chamber.

22. A substrate comprising a surface having a polymer coating formed thereon by a plasma polymerisation method according to claim 1.

23. A substrate according to claim 22, wherein the surface thereof includes a metal element, a metalloid element or a combination thereof prior to having the polymer coating deposited thereon.
